(19) United States
(12) Patent Application Publication
(10) Pub. No.: US 2013/0155098 A1
(43) Pub. Date: Jun. 20, 2013

(54) Adjusting Fonts for Visual Consistency

(71) Applicants: Thomas A. Rickner, Madison, WI (US); David G. Opstad, Mountain View, CA (US)

(72) Inventors: Thomas A. Rickner, Madison, WI (US); David G. Opstad, Mountain View, CA (US)

(73) Assignee: Monotype Imaging Inc.

(21) Appl. No.: 13/329,771

(22) Filed: Dec. 19, 2011

(51) Int. Cl. G09G 5/00

(52) U.S. Cl. 345/619

(57) ABSTRACT

A computing device-implemented method includes analyzing a set of executable instructions that define an outline of a font glyph for assigning points of the outline into two or more groups. The method also includes manipulating the points assigned to the two or more groups for adjusting the displayed appearance of the font glyph.

### BACKGROUND

This description relates to techniques for adjusting fonts for presentation while retaining legibility for visual consistency.

The demand for scaling the size of electronic displays (e.g., for large televisions, small mobile telephones, etc.) similarly drives the scaling of graphical content for presentation. For example, font characters may be scaled down for being presented on a relatively small display. However, the intricate shapes of some characters (e.g., in languages such as Korean) may not lend well to being scaled down for reduced number of pixels included in a small display. Further, some fonts are produced by merging together two or more different fonts, which may introduce misalignments and further reduce visual consistency when scaled down.

### SUMMARY

The systems and techniques described here relate to appropriately adjusting font characters to retain legibility and visual consistency.

In one aspect, a computing device-implemented method includes analyzing a set of executable instructions that define an outline of a font glyph for assigning points of the outline into two or more groups. The method also includes manipulating the points assigned to the two or more groups for adjusting the displayed appearance of the font glyph.

Implementations may include any or all of the following features. Analyzing the set of executable instructions may include parsing the instructions to identify points of the outline of the font glyph. The points may be assigned into one of three groups. The executable instructions may be hinting language instructions. The executable instructions may be TrueType instructions. Manipulating the points may include shifting the position of each respective point. Manipulating the points may include comparing the position of one of the points to the position of a reference point. Manipulating the points may include shifting the position of the respective point along a first dimension. The first dimension may lie along a vertical direction. The displayed appearance of the font glyph may be adjusted along a vertical direction.

In another aspect, a system includes a computing device for analyzing a set of executable instructions that define an outline of a font glyph for assigning points of the outline into two or more groups. The computing device is configured to manipulate the points assigned to the two or more groups for adjusting the displayed appearance of the font glyph.

Implementations may include any or all of the following features. Analyzing the set of executable instructions may include parsing the instructions to identify points of the outline of the font glyph. The points may be assigned into one of three groups. The executable instructions may be hinting language instructions. The executable instructions may be TrueType instructions. Manipulating the points may include shifting the position of each respective point. Manipulating the points may include comparing the position of one of the points to the position of a reference point. Manipulating the points may include shifting the position of the respective point along a first dimension. The first dimension may lie along a vertical direction. The displayed appearance of the font glyph may be adjusted along a vertical direction.

In still another aspect, one or more computer readable media storing instructions that are executable by a processing device, and upon such execution cause the processing device to perform operations that include analyzing a set of executable instructions that define an outline of a font glyph for assigning points of the outline into two or more groups. The operations also include manipulating the points assigned to the two or more groups for adjusting the displayed appearance of the font glyph.

Implementations may include any or all of the following features. Analyzing the set of executable instructions may include parsing the instructions to identify points of the outline of the font glyph. The points may be assigned into one of three groups. The executable instructions may be hinting language instructions. The executable instructions may be TrueType instructions. Manipulating the points may include shifting the position of each respective point. Manipulating the points may include comparing the position of one of the points to the position of a reference point. Manipulating the points may include shifting the position of the respective point along a first dimension. The first dimension may lie along a vertical direction. The displayed appearance of the font glyph may be adjusted along a vertical direction.

These and other aspects and features and various combinations of them may be expressed as methods, apparatus, systems, means for performing functions, program products, and in other ways.

Other features and advantages will be apparent from the description and the claims.

### DESCRIPTION OF DRAWINGS

FIG. 1 illustrates adjusting a font character in the vertical direction.

FIGS. 2-4 illustrate adjustments to an outline of a font character.

FIG. 5 illustrates a system for adjusting the visual appearance of font characters.

FIG. 6 is a representative flow chart of operations for adjusting font characters.

FIGS. 7 and 8 illustrate executable instructions for defining a font character.

FIG. 9 is a block diagram of computing devices and systems.

### DETAILED DESCRIPTION

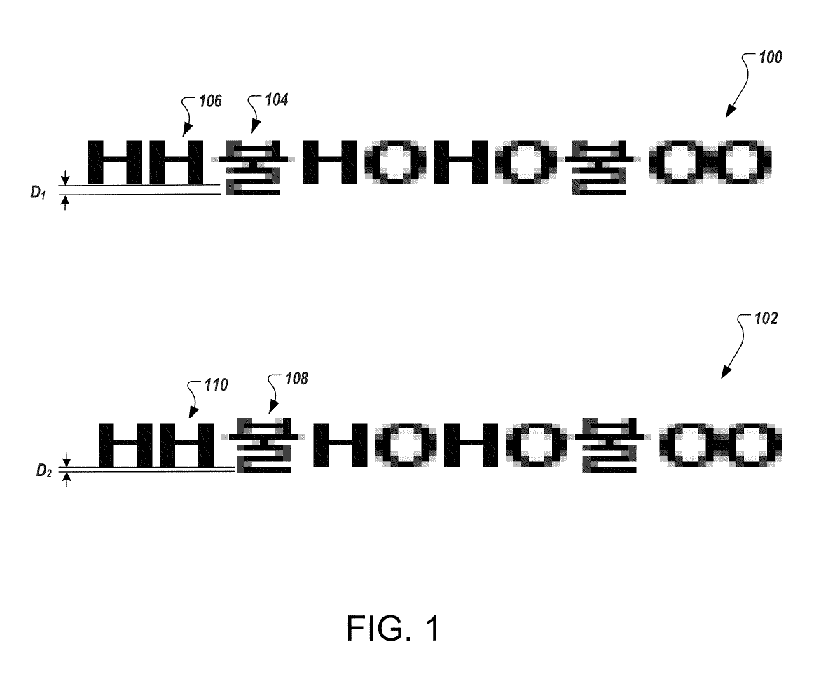

Referring to FIG. 1, two strings of characters 100, 102 are presented that both contain glyphs produced from two different fonts, a Latin font and a Korean font. By merging two or more fonts, as demonstrated in the figure, a new font may be produced that includes a larger set of characters. However, the merged font sets may not appear appropriate to an end-viewer due to misalignments between glyphs of the two different fonts. For example, the vertical alignment of one font may not match glyphs of the other font. As illustrated in string 100, the vertical positioning of one Korean glyph 104 is not optically centered within the Latin glyphs (e.g., Latin glyph 106). To quantify the difference between the two glyphs in the vertical direction, a distance D₁ provides a measure of the difference between the baselines of the two glyphs.

To adjust the glyphs of the two fonts into alignment, one or more operations may be executed on one or both of the glyphs. For example, glyphs of one or both of the fonts may be raised or lowered along the vertical direction. In general, glyphs are initially created in a design space and coordinates are represented by an associated unit of measure (e.g., “unit per em” or “upem”). For example, fonts associated with an outline font standard such as TrueType fonts, typical values may be 2048 upem, however other units of measure may be employed. In general, TrueType fonts can be considered as having glyphs that are described by outlines. A glyph outline may consist of a series of contours (a simple glyph having one contour, and, a more complex glyph having two or more contours). Each contour may be composed of one or more straight lines and curves, in which one or more models (e.g., Bezier-splines) may be used to define the curves. For TrueType fonts, points that define the outline of a glyph may be described in font units (FUnits). To represent glyphs, outline font standards such as TrueType generally employ a hinting language to allow the glyphs to be scaled (for use on different display devices) while retaining their aesthetics and legibility. By using such hinting languages, which can be considered stack-based languages, each glyph in a font can be represented by executable instructions that allow the points of the glyph's outline to be manipulated prior to rasterization. However, during rasterization for preparing the glyphs for presentation on a device, errors may be introduced such as font misalignment along one or more dimensions (e.g., vertical dimension). To align the glyphs, as in the illustrated example, the baseline of the Korean glyphs included in the string 102 may be raised to improve vertical alignment with the Latin glyphs also included in the string. For example, a distance D₂ provides a measure of the difference between a raised-baseline Korean glyph 108 (included in the string 102) and a Latin glyph 110. Compared to the distance D₁ (measured in string 100), the vertical alignment of the glyphs is improved as represented by the smaller value of distance D₂.

Glyph misalignment may be triggered from various situations, including merging two or more different characters. For example, when a font is scaled and rasterized for presentation on a device (e.g., a mobile telephone), points that represent the outline of the font glyphs are converted from units in the design space (e.g., design units) to units in a device space (e.g., device units) that may be represented in discrete units (e.g., 1/64^{th} of a pixel). To counter the sources of glyphs misalignment, e.g. appropriately raised glyph baselines, one or more methodologies may be implemented. For example, instructions (e.g., TrueType instructions) used to define the character glyphs may be used to reduce some of these typographical distortions.

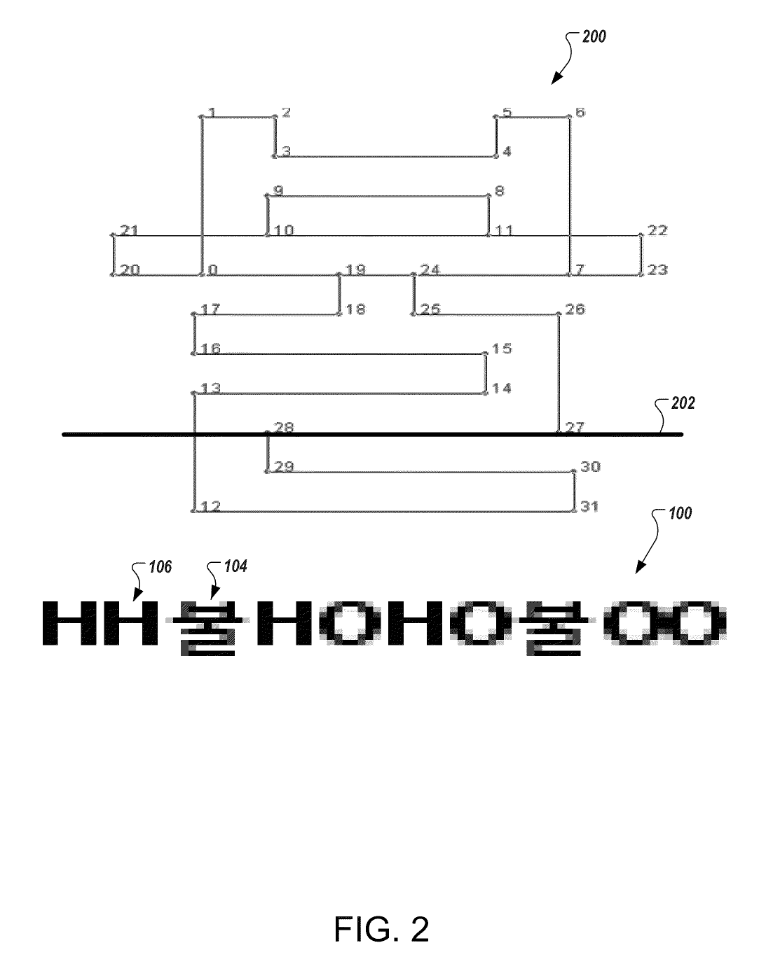

Referring to FIG. 2, a representation 200 of the outline of the Korean glyph 104 (as shown in the string 100) is presented in which a numerical value is assigned to each point that defines the geometry of the character outline. Additionally, a line 202 represents the baseline of the Latin glyphs (e.g., glyph 106) included in the string 100. As provided by the line 202, the outline of the glyph 104 needs to be raised in the vertical direction to appropriately align the glyph with the Latin glyphs included in the string 100. However, simply raising or lowering the outline of the glyph may result in changes in pixel patterns (with respect to the display). As such, after being shifted in location the glyph may appear distorted and inappropriate for presentation.

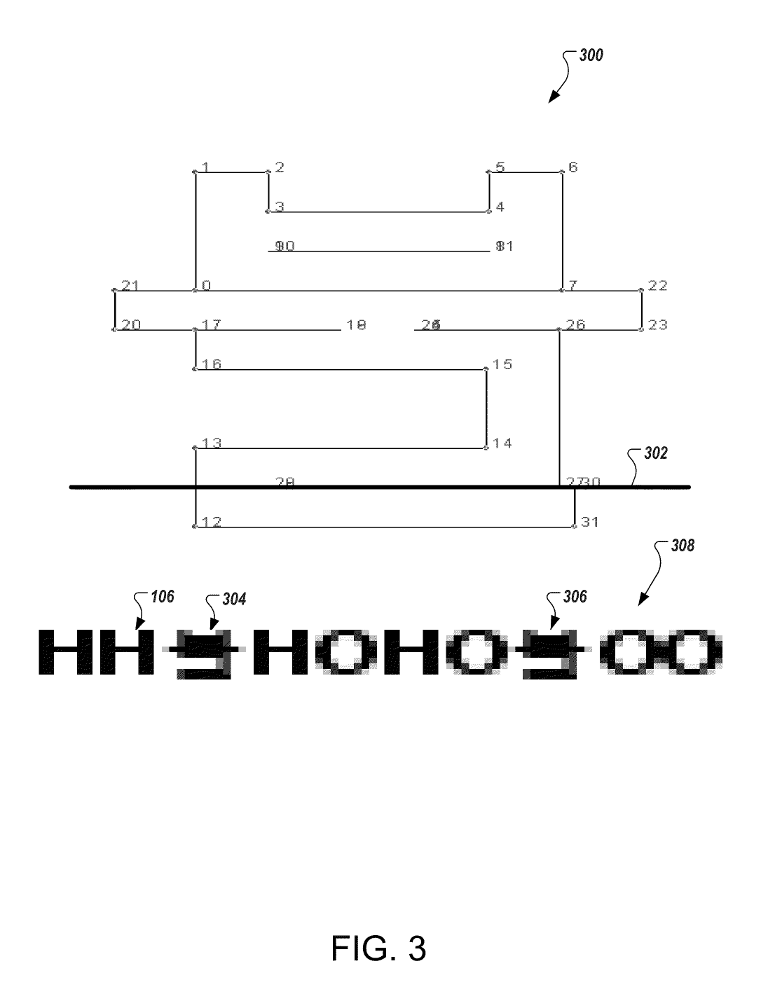

Referring to FIG. 3, a representation of a shifted outline 300 is presented of the outline representation 200 shown in FIG. 2. In particular, the glyph outline 300 has been shifted in the vertical direction by an amount (as represented by a baseline 302) in an attempt to align with other glyphs (e.g., Latin glyphs). Compared to the baseline represented in FIG. 2 (by the line 202), the glyph represented by the shifted outline 300 has shifted in the vertical direction. However, based upon the shifting operations, the shifted outline 300 is deformed and includes portions that have collapsed (compared to the outline 200 in FIG. 2). Such artifacts may appear during the conversion of the coordinates of the outline from a design space to a device space (e.g., TrueType instructions are executed on scaled outlines in device space rather than on outlines in design space). As provided by the distorted outline, the represented glyph may appear ill-shaped and practically unrecognizable and unreadable to a viewer. To demonstrate the distortion, Korean glyphs 304, 306 that correspond to the shifted outline 300 are illustrated within a string 308 that includes the Latin glyphs (e.g., glyph 106). While the Korean glyphs appear to be vertically aligned with the Latin glyphs, compared to non-shifted Korean glyphs (e.g., the glyph 104 shown in FIG. 2), the shifted Korean glyphs 306, 308 appear distorted and illegible.

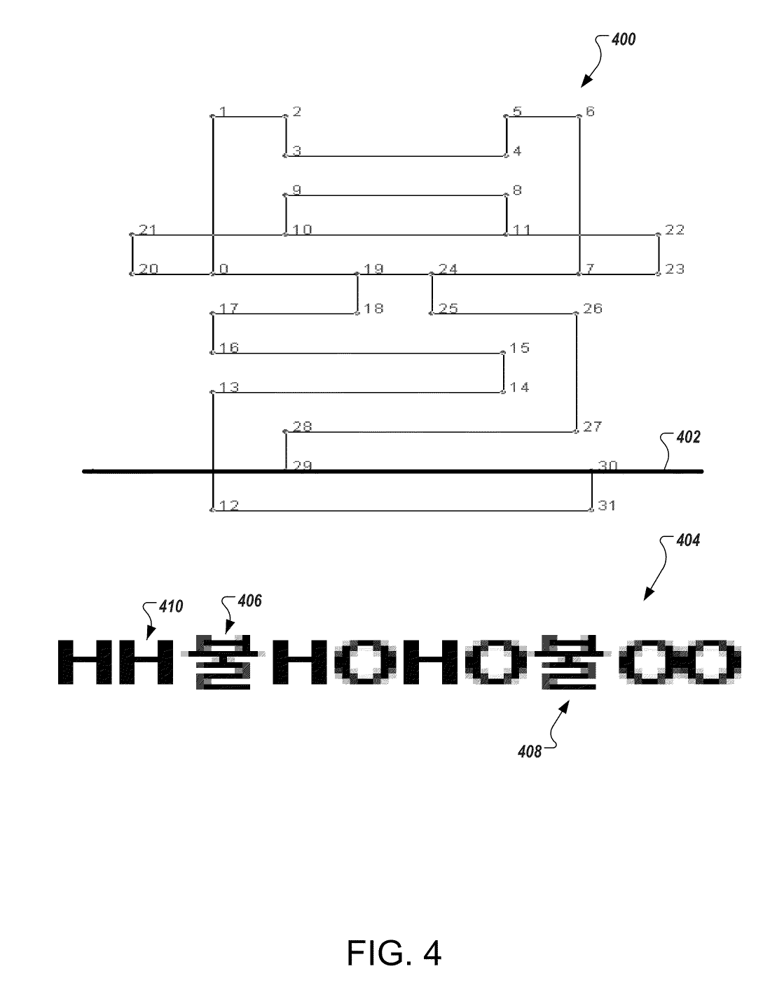

Referring to FIG. 4, one or more methodologies and techniques may be implemented to appropriately shift the outline of a glyph while attempting to retain the shape of the glyph. For example, the instructions that define the outline may be analyzed to identify adjustments to properly shift the outline while replicating the shape of the original outline. In one implementation, based upon the analysis, one or more new instructions may be added to the instructions (e.g., TrueType instructions) that define the outline. For example, inserted instructions (e.g., referred to as Delta hints such as DeltaP) may perform shift operations on identified outline points for such adjustments. In general, the instructions can be used to fine tune a font (e.g., for low resolution sizes) by allowing a point to be moved based upon a unit of measure (e.g., moved in fractions of a pixel). Such instructions can be useful for removing and adding pixels. For this application, the instructions can also be used for shifting portions or an entire outline of a glyph. By executing these additional instructions, the appropriate shape of a shifted outline may be produced. As illustrated in the figure, by implementing such a methodology, an outline 400 of the Korean glyph may be produced that is shifted in the vertical direction while retaining the shape of the non-shifted version of the outline (e.g., the outline 200 shown in FIG. 2). To illustrate the vertical shift of the outline, a line 402 represents the baseline of glyphs of another font present in the string (e.g., Latin font glyphs). Relative to the line 402, the outline has shifted in the vertical direction. As such, Korean glyphs that correspond to the shifted outline 400 may be inserted into a string 404 and more appropriately align in the vertical direction with glyphs being presented in other fonts. For example, as illustrated in the figure, Korean glyphs 406, 408, which are inserted into the string 404 that includes Latin glyphs (e.g., glyph 410), appear properly shifted in the vertical direction for alignment and substantially retain the shape of the original glyph outline.

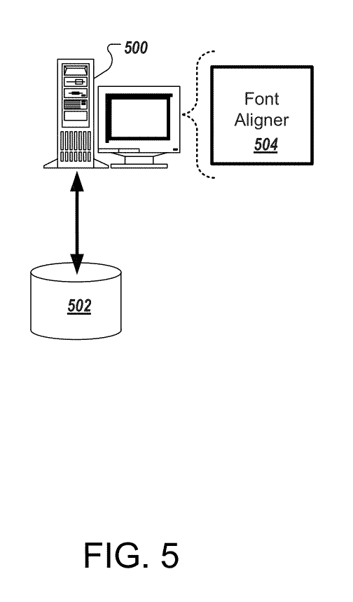

Referring to FIG. 5, to properly adjust the alignment of glyph outlines while substantially retaining the glyph's shape, one or more types of computing devices and system architectures may be implemented. For example, outline adjustments may be provided by operations executed by a single computing device (e.g., computer system, tablet computing device, smart phone, etc.). Such operations may also be executed by multiple devices (e.g., servers, laptop computers, mobile telephones, etc.) for aligning glyph outlines for different fonts while retaining their shapes. In some arrangements, the glyph outline adjustments may be provided as a network service for multiple network information sources. As illustrated in the figure, a computer system 500 is presented that is in communication with a storage device 502 (e.g., a hard drive, CD-ROM, etc.) that is capable of storing various types of data (e.g., files for defining glyphs for different fonts). A font aligner 504 is executed by the computer system 500 to appropriately adjust glyph outlines while substantially retaining the shape of the glyphs. For example, the font aligner 504 may analyze instructions (e.g., TrueType instructions) from files stored in the storage device 502 or from one or more other sources (e.g., other storage devices, Internet-accessible remotely-located storage and computing devices, etc.). To perform such operations, the font aligner 504 may include one or more processing stages, however for illustrative purposes a single stage is presented. In general, the font aligner 504 compares a glyph defined by the outline coordinates and related instructions in the one or more files (e.g., TrueType instructions) to a shifted version of the glyph. To gather data for comparing to the shifted version of the glyph, the font aligner 504 reviews (e.g., parses) the file(s) instructions (e.g., TrueType instructions) to identify points that define the glyph. Identified, each point is labeled as being in one of multiple point categories. Once the categories are populated with the identified points, the font aligner 504 appropriately processes the categorized points to substantially match the positions of the points with corresponding points in the shifted version of the glyph. Such processing may include, for example, inserting additional instructions (e.g., DeltaP instructions) into the file(s) for adjusting the positions of the points as defined by the instructions (e.g., TrueType instructions). Along with being aligned to the shifted version of the glyph, by appropriately adjusting the categorized points with the newly introduced (DeltaP) instructions, the glyph defined by the edited instructions (TrueType instructions) substantially retains its originally designed shape.

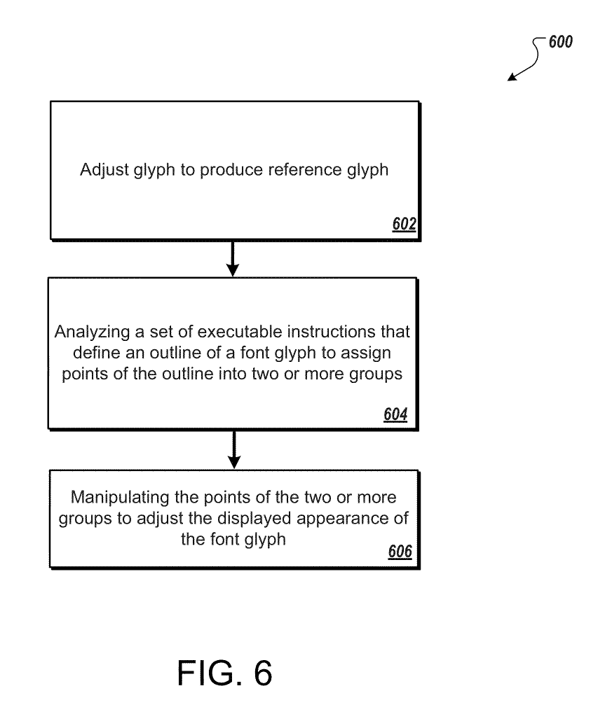

Referring to FIG. 6, a flowchart 600 represents operations of a computing device such as the computer system 500 (shown in FIG. 5) to adjust the coordinates of data points that represent a glyph to improve alignment (e.g., in the vertical direction) with glyphs in one or more other fonts. Such operations, e.g., of the font aligner 504, are typically executed by components (e.g., processors, display controllers, etc.) included in a single computing device (e.g., the computer system 500, shown in FIG. 5); however, operations may be executed by multiple computing devices. Along with being executed at a single site (e.g., at the site of the computer system 500), operation execution may be distributed among two or more locations.

Upon receiving the one or more files that store the outline of a glyph (e.g., stored in one or more files in the storage device 502), the glyph is adjusted 602 (e.g., shifted) in the direction of interest (e.g., the vertical direction) to produce reference glyph for comparison. This reference glyph is represented in units associated with the design space of the font (e.g., design units such as FUnits). The instructions (e.g., TrueType instructions) from the one or more files can be considered as substantially ensuring that the characteristics of the glyph are preserved for rendering the glyph at different sizes upon different display devices. From these instructions, the font aligner 504 may perform adjustments (e.g., insert additional instructions) such that a glyph is produced by the adjusted instructions substantially aligns with the reference glyph and retains its original shape.

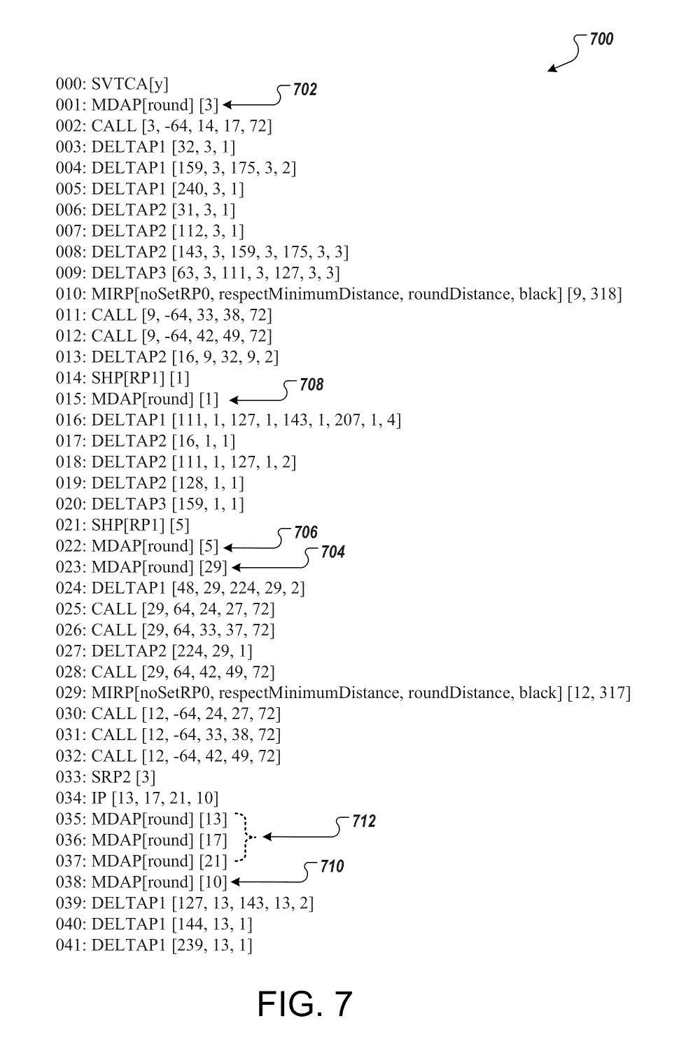

To perform such an alignment, operations include analyzing 604 the instructions (e.g., TrueType instructions) to identify points included in the outline of the glyph and include each identified point in one of multiple groups. To define the groups, into which points may be assigned, one or more techniques and methodologies may be implemented. For example, three groups may be defined for accepting points as members. For this technique, membership in the groups is determined from the use of the outline points by the instructions (e.g., TrueType instructions). For example, one group of points (referred to as “parent” points) may be considered points that provide a reference point (e.g., an anchor point) to other points and features of the glyph. Generally such parent points are located at prominent locations on a glyph (e.g., top or bottom position of a stem). To identify such parent points, in one arrangement, the instructions may be parsed for instructions that may be associated with parent points. For example, a TrueType instruction associated with setting a reference point (e.g., move direct absolute point (MDAP) instruction) may be considered an instruction that identifies a parent point. Briefly referring to FIG. 7, a listing 700 of TrueType instructions for defining a glyph are presented, and for demonstrative purposes these instructions may be parsed by the font aligner 504 to identify parent points. In this implementation, parent points may be identified from their initial appearance. As such, the instruction listing 700 may be parsed in a serial manner (e.g., starting with the first instruction line and stepping to the final instruction line). For example, as highlighted with arrow 702, line “001” in the listing 700 reads “MDAP[round] [3]” to indicate that point 3 in the outline of the glyph is used in a Move Direct Absolute Point instruction. Further this instruction is the first instance of point 3 being used. Based upon the use of this point in the MDAP instruction and not being used in previous instructions, point 3 can be identified as a parent point. Similarly, as highlighted by arrow 704, the point 29 is used in an MDAP instruction at line “023” (i.e., 023:MDAP[round][29]) and is not used in a previous instruction line in the listing 700. As such, similar to point 3, point 29 of the glyph outline can be categorized as a parent point.

Along with parent points, the second of the three groups for categorizing identified points can be referred to as “children points”. In general, a child point may be considered a point that does not provide a reference point but instead depends upon a reference point (e.g., a parent point). Due to the dependency to its parent point, a child point may be adjusted based upon adjustments to the parent point. For example, if a parent point is moved by a particular amount (e.g., one pixel), the child point (or children points) correspondingly moves by the same amount. With respect to TrueType instructions, one or more rules may be used to define a child point. For example, a point may be considered a child point if it is first used by an instruction such as a Set Reference Point (SRP) instruction, an Interpolate Point (IP) instruction, a Shift Point (SHP) instruction, etc. After this initial use, the point may or may not be used by another instruction, including an MDAP instruction. Referring to the listing 700 shown in FIG. 7, one child point is included. In particular, as highlighted with arrow 706, point 5 is used in a MDAP instruction (i.e., “022: MDAP[round][5]”), and is also used in the previous line in an SHP instruction (i.e., “021: SHP[RP1][5]”). As such, point 5 is not used as a reference point prior to line 021 and can be considered a child point based upon the parsing of the listing 700 by the font aligner 504. The third group that may be used to categorize points can be referred to as “parent/children” points, which include points that may be considered as child points (to one or more parent points) and that also serve as parent points for other points. With reference to TrueType instructions, parent/children points may be considered as children points that are subsequently used as reference points for instructions such as DeltaP instructions, Move Direct Relative Point (MDRP) instructions, Move Indirect Relative Point (MIRP), SHP instructions, SRP instructions, Shift Point by a Pixel Amount (SHPIX) instructions, IP instructions, MDAP instructions, etc.

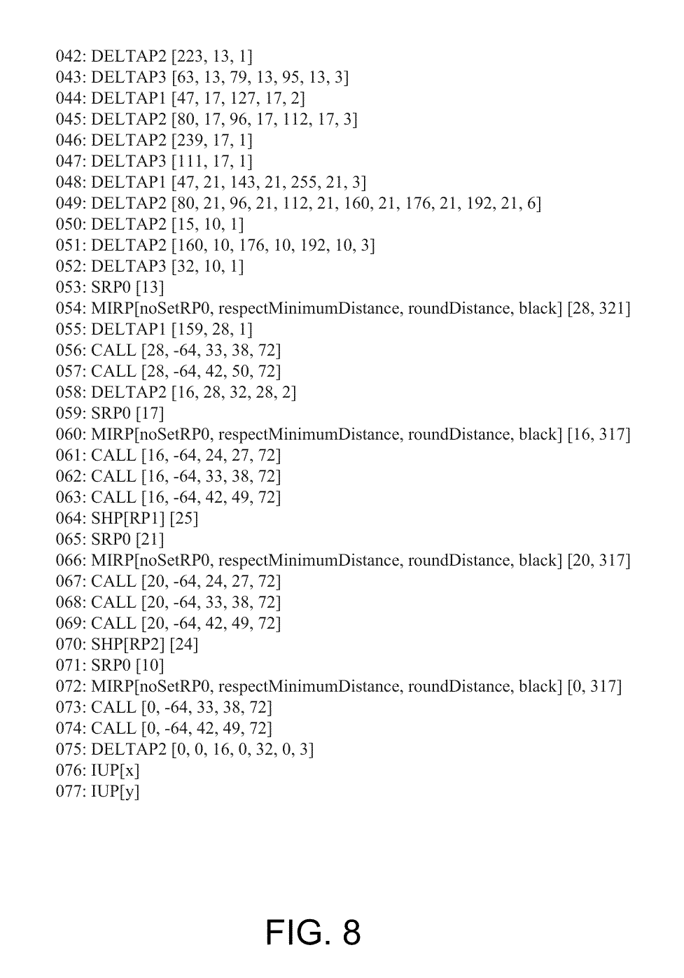

In the example instruction listing 700 shown in FIG. 7 and continuing onto FIG. 8, points 1, 10, 13, 17 and 21 can be categorized as parent/children points. For example, as highlighted with arrow 708, point 1 is used in a MDAP instruction on line 015 (i.e., “MDAP[round][1]”) after being previously used on line 014 (i.e., “SHP[RP1] [1]”), which categorizes point 1 as a child point. Additionally, point 1 is used as a reference point in subsequent instructions provided in lines 016 to 020 (i.e., DELTAP1 [111, 1, 127, 1, 143, 1, 207, 1, 4] . . . DELTAP3 [159, 1, 1]). As such, point 1 can be categorized as a parent/child point. As highlighted by arrow 710, point 10 is used in line 038 by a MDAP instruction (i.e., MDAP[round][10]) after being used by line 034 in an IP instruction, thereby categorizing point 10 as a child. However, in lines 050 to 052 (shown in FIG. 8), point 10 is also used as a reference in series of DeltaP instructions (i.e., DELTAP2 [15, 10, 1] . . . DELTAP3 [32, 10, 1]). As such, point 10 also serves as a parent point and can be considered a parent/child point. Regarding points 13, 17 and 21, each are respectively anchored with MDAP instructions in lines 035, 036 and 037 as highlighted by arrow 712. Previously, on line 034 each of these points are used in an IP instruction (i.e., IP[13, 17, 21, 10]). As such, each of points 13, 17 and 21 can be considered as a child point. Further, since each of these points are used as reference points in DeltaP instructions on lines 039-049 (i.e., DELTAP1 [127, 13, 143, 13, 2] . . . DELTAP2 [80, 21, 96, 21, 112, 21, 160, 21, 176, 21, 192, 21, 6]), the points can also be considered as parent points. As such, points 13, 17 and 21 can be considered as parent/children points. In this particular arrangement, three groups (i.e., parent, child and parent/children groups) are used to categorize the points of a glyph outline, however more or less categories may be used in other arrangements.

Returning to FIG. 6 upon analyzing the instructions to identify the member points for the groups (e.g., parent, child, parent/child), operations of the font aligner 504 include manipulating 606 the points included in the groups to adjust the appearance of the font glyph (e.g., for aligning with one or more other font glyphs). Based upon the number of groups defined and populated member points, one or more techniques may be implemented for manipulating the points. For example, manipulating the points may first include shifting the locations of the points identified as parent points. For each parent point, the location (e.g., coordinates) of the parent point can be compared to the location of a corresponding point in the outline of the shifted reference glyph. Based upon this comparison (e.g., to determine location difference and shift direction), the location of the parent point may be adjusted (e.g., by inserting a DeltaP instruction into the file that defines the glyph). If the locations are substantially equivalent, no instruction may need to be inserted. Typically, shifting the parent points can be executed in a serial manner. Based upon the adjustments to the parent points, other points may change location. For example, one or more points (e.g., children points) that depend upon one or more parent points may correspondingly change location. With respect to the instructions provided in FIGS. 7 and 8, being identified as parent points, the respective locations of point 3 and 29 may be compared to corresponding points in the outline of the shifted reference glyph. If needed, one or more instructions (e.g., DeltaP instructions) may be inserted in the listing 700 for appropriately adjusting the locations of points 3 and 29 to substantially match the locations of the corresponding points in the shifted glyph outline.

Upon shifting the parent points, if needed, manipulating 606 may include shifting the points identified as parent/children points. One or more techniques or methodologies may be implemented for shifting parent/children points. For example, similar to shifting the parent points, a font aligner 504 may compare each parent/child point to a corresponding point in the reference glyph and determine if the parent/children point needs to be shifted (e.g., the location of the parent/children point does not match the location of the corresponding point in the reference glyph). However, due to potential interrelationships of the parent/children points with other points (and possibly amongst themselves), multiple shift operations may be executed on parent/children points thereby positioning the points in incorrect locations. By their nature, parent/children points may depend upon one or more parent points (e.g., functioning as a child in a parent/child relationship) and also serve as a parent point (e.g., functioning as a parent in a parent/child relationship). As such, situations may occur in which a parent/children point may be shifted more than once when only a single shift operation is needed. For example, based upon its parent point (or multiple parent points) being shifted, the parent/children point may correspondingly be shifted (e.g., based upon being a child in the parent/child relationship). The parent/child point may then be additionally shifted by the font aligner 504 for being a parent/child point (at this stage in the process). Further, the parent/child point may be shifted again due to the shifting of another parent/child (e.g., based upon being a child point of the parent/child point). As such, multiple shift operations may be inadvertently executed on the same parent/children point and the location of the point may appear to change (e.g., visually wiggle) as other parent/child points are shifted. One or more techniques may be used to address the potential multiple shifting of parent/children points. For example, rather than just using one iteration to shift parent/child points (based upon comparisons to corresponding points of the reference glyph), multiple iterations may be employed. As such, during subsequent checks on the position of the parent/child points, one or more instructions (e.g., shift instructions) may be added or removed by the font aligner 504 to address cyclical changes (e.g., visual wiggling) of the parent/child point. Based upon these operations, the font aligner 504 can monitor the parent/children points over a number of iterations (e.g., two or three passes through to check the positions of the parent/children points) until the position of each parent/children point has reached a quiescent location.

Upon the parent points and the parent/children points being appropriately shifted (as compared to the points of the reference glyph), manipulating 604 may include shifting the points identified as children points. One or more techniques or methodologies may be implemented by the font aligner 504 for determining if shift operations are needed for one or more children points and executing any needed shift operations. For example, similar to shifting the parent points, during a single iteration, the technique may compare each child point to a corresponding point in the outline of the reference glyph and determine if the child point needs to be shifted (e.g., the location of the child point does not match the location of the corresponding point in the reference glyph).

Upon appropriately shifting parent, parent/children and children points, one or more additional operations may be executed by the font aligner 504. For example, one or more files may be stored (for later retrieval and use) that reflect the instruction adjustments (e.g., added, changed, and/or removed TrueType instructions) for aligning the glyph represented by the one or more files. Additional operations may include providing the one or more files for further processing and use such as rendering the glyph for display on one or more devices.

Along with adjusting the glyph alignment in the vertical direction, similar adjustments may be provided by the operations of the font aligner 504 in other directions and dimensions. For example, similar operations may be executed for aligning one or more glyphs in the horizontal direction (e.g., in combination with adjustments in another direction or in isolation). The operations may also be executed for aligning one or more glyphs in multiple directions (e.g., vertical, horizontal, one or more diagonal directions, etc.).

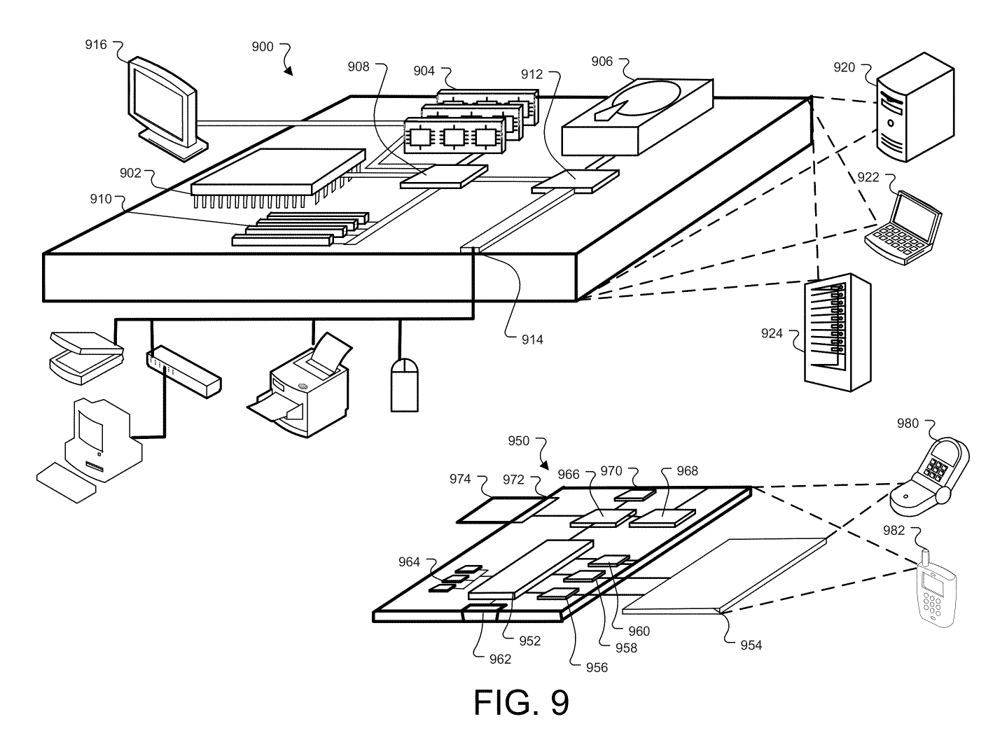

FIG. 9 shows an example of example computer device 900 and example mobile computer device 950, which can be used to implement the techniques described herein. For example, a portion or all of the operations of the font aligner 504 may be executed by the computer device 900 and/or the mobile computer device 950. Computing device 900 is intended to represent various forms of digital computers, including, e.g., laptops, desktops, workstations, personal digital assistants, servers, blade servers, mainframes, and other appropriate computers.

Computing device 950 is intended to represent various forms of mobile devices, including, e.g., personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 900 includes processor 902, memory 904, storage device 906, high-speed interface 908 connecting to memory 904 and high-speed expansion ports 910, and low speed interface 912 connecting to low speed bus 914 and storage device 906. Each of components 902, 904, 906, 908, 910, and 912, are interconnected using various busses, and can be mounted on a common motherboard or in other manners as appropriate. Processor 902 can process instructions for execution within computing device 900, including instructions stored in memory 604 or on storage device 906 to display graphical data for a GUI on an external input/output device, including, e.g., display 916 coupled to high speed interface 908. In other implementations, multiple processors and/or multiple buses can be used, as appropriate, along with multiple memories and types of memory. Also, multiple computing devices 600 can be connected, with each device providing portions of the necessary operations (e.g., as a server bank, a group of blade servers, or a multi-processor system).

Memory 904 stores data within computing device 900. In one implementation, memory 904 is a volatile memory unit or units. In another implementation, memory 904 is a non-volatile memory unit or units. Memory 904 also can be another form of computer-readable medium, including, e.g., a magnetic or optical disk.

Storage device 906 is capable of providing mass storage for computing device 900. In one implementation, storage device 906 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., memory 904, storage device 906, memory on processor 902, and the like.

High-speed controller 908 manages bandwidth-intensive operations for computing device 900, while low speed controller 912 manages lower bandwidth-intensive operations. Such allocation of functions is an example only. In one implementation, high-speed controller 908 is coupled to memory 904, display 916 (e.g., through a graphics processor or accelerator), and to high-speed expansion ports 910, which can accept various expansion cards (not shown). In the implementation, low-speed controller 912 is coupled to storage device 606 and low-speed expansion port 914. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 900 can be implemented in a number of different forms, as shown in the figure. For example, it can be implemented as standard server 920, or multiple times in a group of such servers. It also can be implemented as part of rack server system 924. In addition or as an alternative, it can be implemented in a personal computer including, e.g., laptop computer 922. In some examples, components from computing device 900 can be combined with other components in a mobile device (not shown), including, e.g., device 950. Each of such devices can contain one or more of computing device 900, 950, and an entire system can be made up of multiple computing devices 900, 950 communicating with each other.

Computing device 950 includes processor 952, memory 964, an input/output device including, e.g., display 954, communication interface 966, and transceiver 968, among other components. Device 950 also can be provided with a storage device, including, e.g., a microdrive or other device, to provide additional storage. Each of components 950, 952, 964, 954, 966, and 968, are interconnected using various buses, and several of the components can be mounted on a common motherboard or in other manners as appropriate.

Processor 952 can execute instructions within computing device 950, including instructions stored in memory 964. The processor can be implemented as a chipset of chips that include separate and multiple analog and digital processors. The processor can provide, for example, for coordination of the other components of device 950, including, e.g., control of user interfaces, applications run by device 950, and wireless communication by device 950.

Processor 952 can communicate with a user through control interface 958 and display interface 956 coupled to display 954. Display 954 can be, for example, a TFT LCD (Thin-Film-Transistor Liquid Crystal Display) or an OLED (Organic Light Emitting Diode) display, or other appropriate display technology. Display interface 956 can comprise appropriate circuitry for driving display 954 to present graphical and other data to a user. Control interface 958 can receive commands from a user and convert them for submission to processor 952. In addition, external interface 962 can communicate with processor 942, so as to enable near area communication of device 950 with other devices. External interface 962 can provide, for example, for wired communication in some implementations, or for wireless communication in other implementations, and multiple interfaces also can be used.

Memory 964 stores data within computing device 950. Memory 964 can be implemented as one or more of a computer-readable medium or media, a volatile memory unit or units, or a non-volatile memory unit or units. Expansion memory 974 also can be provided and connected to device 950 through expansion interface 972, which can include, for example, a SIMM (Single In Line Memory Module) card interface. Such expansion memory 974 can provide extra storage space for device 950, or also can store applications or other data for device 950. Specifically, expansion memory 974 can include instructions to carry out or supplement the processes described above, and can include secure data also. Thus, for example, expansion memory 974 can be provided as a security module for device 950, and can be programmed with instructions that permit secure use of device 950. In addition, secure applications can be provided through the SIMM cards, along with additional data, including, e.g., placing identifying data on the SIMM card in a non-hackable manner.

The memory can include, for example, flash memory and/or NVRAM memory, as discussed below. In one implementation, a computer program product is tangibly embodied in a data carrier. The computer program product contains instructions that, when executed, perform one or more methods, including, e.g., those described above. The data carrier is a computer- or machine-readable medium, including, e.g., memory 964, expansion memory 974, and/or memory on processor 952, which can be received, for example, over transceiver 968 or external interface 962.

Device 950 can communicate wirelessly through communication interface 966, which can include digital signal processing circuitry where necessary. Communication interface 966 can provide for communications under various modes or protocols, including, e.g., GSM voice calls, SMS, EMS, or MMS messaging, CDMA, TDMA, PDC, WCDMA, CDMA2000, or GPRS, among others. Such communication can occur, for example, through radio-frequency transceiver 968. In addition, short-range communication can occur, including, e.g., using a Bluetooth®, WiFi, or other such transceiver (not shown). In addition, GPS (Global Positioning System) receiver module 970 can provide additional navigation- and location-related wireless data to device 950, which can be used as appropriate by applications running on device 950.

Device 950 also can communicate audibly using audio codec 960, which can receive spoken data from a user and convert it to usable digital data. Audio codec 960 can likewise generate audible sound for a user, including, e.g., through a speaker, e.g., in a handset of device 950. Such sound can include sound from voice telephone calls, can include recorded sound (e.g., voice messages, music files, and the like) and also can include sound generated by applications operating on device 950.

Computing device 950 can be implemented in a number of different forms, as shown in the figure. For example, it can be implemented as cellular telephone 980. It also can be implemented as part of smartphone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

Processes described herein and variations thereof (referred to as “the processes”) include functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device-implemented method comprising:
analyzing a set of executable instructions that define an outline of a font glyph for assigning points of the outline into two or more groups; and
manipulating the points assigned to the two or more groups for adjusting the displayed appearance of the font glyph.

2. The computing device-implemented method of claim 1, wherein analyzing the set of executable instructions includes parsing the instructions to identify points of the outline of the font glyph.

3. The computing device-implemented method of claim 1, wherein points are assigned into one of three groups.

4. The computing device-implemented method of claim 1, wherein the executable instructions are hinting language instructions.

5. The computing device-implemented method of claim 1, wherein the executable instructions are TrueType instructions.

6. The computing device-implemented method of claim 1, wherein manipulating the points includes shifting the position of each respective point.

7. The computing device-implemented method of claim 1, wherein manipulating the points includes comparing the position of one of the points to the position of a reference point.

8. The computing device-implemented method of claim 1, wherein manipulating the points includes shifting the position of the respective point along a first dimension.

9. The computing device-implemented method of claim 8, wherein the first dimension lays along a vertical direction.

10. The computing device-implemented method of claim 1, wherein the displayed appearance of the font glyph is adjusted along a vertical direction.

11. A system comprising:
a computing device for analyzing a set of executable instructions that define an outline of a font glyph for assigning points of the outline into two or more groups; and
wherein the computing device is configured to manipulate the points assigned to the two or more groups for adjusting the displayed appearance of the font glyph.

12. The system of claim 11, wherein analyzing the set of executable instructions includes parsing the instructions to identify points of the outline of the font glyph.

13. The system of claim 11, wherein points are assigned into one of three groups.

14. The system of claim 11, wherein the executable instructions are hinting language instructions.

15. The system of claim 11, wherein the executable instructions are TrueType instructions.

16. The system of claim 11, wherein manipulating the points includes shifting the position of each respective point.

17. The system of claim 11, wherein manipulating the points includes comparing the position of one of the points to the position of a reference point.

18. The system of claim 11, wherein manipulating the points includes shifting the position of the respective point along a first dimension.

19. The system of claim 18, wherein the first dimension lays along a vertical direction.

20. The system of claim 1, wherein the displayed appearance of the font glyph is adjusted along a vertical direction.

21. One or more computer readable media storing instructions that are executable by a processing device, and upon such execution cause the processing device to perform operations comprising:
analyzing a set of executable instructions that define an outline of a font glyph for assigning points of the outline into two or more groups; and
manipulating the points assigned to the two or more groups for adjusting the displayed appearance of the font glyph.

22. The computer readable media of claim 21, wherein analyzing the set of executable instructions includes parsing the instructions to identify points of the outline of the font glyph.

23. The computer readable media of claim 21, wherein points are assigned into one of three groups.

24. The computer readable media of claim 21, wherein the executable instructions are hinting language instructions.

25. The computer readable media of claim 21, wherein the executable instructions are TrueType instructions.

26. The computer readable media of claim 21, wherein manipulating the points includes shifting the position of each respective point.

27. The computer readable media of claim 21, wherein manipulating the points includes comparing the position of one of the points to the position of a reference point.

28. The computer readable media of claim 21, wherein manipulating the points includes shifting the position of the respective point along a first dimension.

29. The computer readable media of claim 28, wherein the first dimension lays along a vertical direction.

30. The computer readable media of claim 21, wherein the displayed appearance of the font glyph is adjusted along a vertical direction.
